(19) United States
(12) Patent Application Publication
(10) Pub. No.: US 2013/0064744 A1
(43) Pub. Date: Mar. 14, 2013

(54) HEATED INJECTION SYSTEM FOR DIESEL ENGINE EXHAUST SYSTEMS

(71) Applicant: Yasser Mohamed sayed Yacoub, Koln (DE)

(72) Inventor: Yasser Mohamed sayed Yacoub, Koln (DE)

(73) Assignee: FORD GLOBAL TECHNOLOGIES, LLC, Dearborn, MI (US)

(21) Appl. No.: 13/592,231

(22) Filed: Aug. 22, 2012

(30) Foreign Application Priority Data
Sep. 8, 2011 (EP) 11180569.3

(51) Int. Cl. B01D 53/92; B01F 5/04; B01D 53/94; F16L 53/00

(52) U.S. Cl. 423/212; 137/334; 137/602; 137/896; 422/169

(57) ABSTRACT

Embodiments for injecting reducing agents are provided. In one example, an injection device for feeding reducing agents into an exhaust-gas purification system of an internal combustion engine for reduction of nitrogen oxide emissions comprises an injector, and an evaporation device for evaporating first and second reducing agents, the injection device connected to in each case one storage vessel for the first reducing agent and a storage vessel for the second reducing agent, the first and second reducing agents liquid at room temperature.

### RELATED APPLICATIONS

The present application claims priority to European Patent Application Number 11180569.3, filed on Sep. 8, 2011 the entire contents of which are hereby incorporated by reference for all purposes.

### FIELD

The present disclosure relates to an injection device for feeding reducing agents into an exhaust system of an internal combustion engine for the reduction of the nitrogen oxide emissions, in particular of a diesel engine.

### BACKGROUND AND SUMMARY

Various exhaust-gas purification systems are known from previous systems. According to a first possibility, in an LNT (lean NOx trap), NOx is absorbed from the exhaust-gas flow conducted through and is temporarily stored. Since the storage capacity of an LNT is naturally limited, the stored NOx is removed from time to time. For this purpose, the operating parameters of the engine are changed from a lean mode during the storage process to a rich mode. In the rich mode, the engine is operated with superstoichiometric quantities of fuel in relation to the combustion air. This leads to an enrichment of the combustion exhaust gases with carbon monoxide (CO) and hydrocarbons (HC). At the same time, the rich mode causes the exhaust-gas temperature to increase. As a result, the temperature in the LNT catalytic converter increases, wherein now, CO and HC will additionally pass from the exhaust gases into the LNT during the rich pulse mode.

The LNT catalytic converter has a coating with metals from the platinum group. These catalyze various redox reactions between the stored NOx and the CO and HC which function as reducing agents, wherein NOx is converted into nitrogen and water. After conversion of the stored NOx, the engine is switched back into the lean mode, and the storage cycle starts again.

The noble metals used for the reduction of the stored NOx in conventional LNT catalytic converters significantly increase the costs of these catalytic converters. Furthermore, the production of such systems is expensive. Furthermore, some catalytic converter systems are sensitive to catalyst poisons such as hydrogen sulfide and other sulfur compounds which may arise during the combustion of sulfur-containing fuel and which influence the catalytic activity. Said compounds may duly also generally be broken down by the noble metal coating, but the high catalytic converter temperatures used for this purpose considerably shorten the service life of the catalytic converter.

An LNT catalytic converter of the abovementioned type is known for example from EP 1 004 347 B1. The catalytic converter disclosed in said document is of two-layer construction, wherein a first layer is responsible for the NOx storage and a second layer contains noble metal components, with the aid of which NOx is to be broken down. Said catalytic converter is kept continuously lean/rich, that is to say not in alternating operation, and here attains a conversion rate of approximately 20 to 30% of the nitrogen oxides flowing through.

Aside from the abovementioned LNT catalytic converters, other catalytic converter systems are known which reduce the nitrogen oxide content in exhaust gases using externally fed-in reducing agents. The reducing agent is generally injected into the exhaust-gas flow by means of an injection device. A so-called SCR catalytic converter arranged downstream of the injection device then effects the actual conversion. SCR (selective catalytic reduction) refers to the technique of the selective catalytic reduction of nitrogen oxides in exhaust gases of combustion plants, refuse combustion plants, gas turbines, industrial plants and engines. The chemical reaction in the SCR catalytic converter is selective, that is to say preferentially the nitrogen oxides (NO, NO₂) are reduced whereas undesired secondary reactions (such as for example the oxidation of sulfur dioxide to form sulfur trioxide) are substantially suppressed. SCR catalytic converters are often used in combination with soot particle filters and oxidation catalytic converters.

A reducing agent is required for the abovementioned reduction reaction, with ammonia (NH₃) typically being used as reducing agent. Here, the ammonia is generally used not directly, that is to say in pure form, but rather is used in the form of a 32.5% aqueous urea solution, referred to uniformly in the industry as AdBlue®. The composition is regulated in DIN 70070. The reason why the ammonia is not carried on board in pure form is the fact that this substance is hazardous Ammonia has a caustic effect on skin and mucous membranes (in particular on the eyes), and furthermore it forms an explosive mixture in air.

When the abovementioned urea solution is injected into the hot exhaust-gas flow, ammonia and carbon dioxide are formed from it through a decomposition reaction. The ammonia generated in this way is then available in the SCR catalytic converter arranged downstream. During the conversion of ammonia with the nitrogen oxides in the exhaust gas, a comproportionation reaction takes place, with water (H₂O) and nitrogen (N₂) being formed. With SCR catalytic converters, a distinction is typically made between two different types of catalytic converters. One type is composed substantially of titanium dioxide, vanadium pentoxide and tungsten oxide. The other type uses zeolites.

The amount of urea injected is dependent on the nitrogen oxide emissions of the engine and therefore on the present rotational speed and the torque of the engine. The consumption of urea-water solution amounts to approximately 2 to 8% of the diesel fuel used, depending on the untreated emissions of the engine. It is therefore necessary for a corresponding tank volume to be provided on board, which is in part perceived to be disadvantageous. In particular, this opposes the use in diesel-operated passenger motor vehicles, because an additional tank is to be provided.

Nitrogen oxides are removed from the exhaust gas to a great extent by means of selective catalytic reduction. In contrast to a diesel particle filter (DPF) or the above-described LNTs, there is no excess fuel consumption for the reduction of pollutants, because in contrast to the abovementioned catalytic converters, an SCR catalytic converter does not use temporary deviations from optimum combustion conditions during operation.

When using SCR technology in utility vehicles, for example, the ammonia, in the form of AdBlue®, for operation gives rise to further requirements. Owing to its particular properties, it is carried on-board as a further operating medium in a high-grade steel or plastic tank, and continuously injected into the exhaust-gas flow. As a result, aside from the SCR catalytic converter and the injection system, there is a need for a second, usually smaller tank aside from the diesel tank.

Furthermore, it may be noted that, during operation, AdBlue® may be injected in a variable fashion. It has hitherto been necessary for the AdBlue® to be adapted to the NOx in the exhaust-gas mass flow by means of a so-called feed ratio. Here, if too much urea is dosed in, the ammonia formed from this can no longer react with NOx. In the event of such an incorrect dosing, ammonia can pass into the environment. Since ammonia is perceptible even in very small concentrations, this leads to an unpleasant smell.

Whereas the abovementioned catalytic reactions take place at an adequately high rate at high exhaust-gas temperatures, the conversion efficiency at low exhaust-gas temperatures is generally unsatisfactory. SCR catalytic converters are duly generally capable of storing nitrogen oxides over a certain period of time, for example until the exhaust line of the engine is at operating temperature and the exhaust-gas flow has the indicated temperature. However, the minimum exhaust-gas temperature for optimum operation is for example often not attained in urban driving situations, such that after a certain period of operation, the maximum storage capacity of the SCR catalytic converter is exceeded, and nitrogen oxides pass into the environment.

At the same time, the exhaust-gas temperature is possibly not adequate for a quantitative decomposition of the urea into ammonia and carbon dioxide, such that adequate amounts of ammonia cannot be formed. The latter problem may duly be at least partially compensated for by an increase in the amount of urea injected, but the actual amount of catalytically active ammonia formed is then difficult to predict. If the amount of urea injected is increased, a situation may also arise in which more ammonia is formed than is consumed in the SCR catalytic converter, as a result of which ammonia passes into the environment. This is undesirable owing to the unpleasant smell and also from a toxicological aspect.

To address this problem, DE 103 48 800 A1 proposes a diesel exhaust-gas aftertreatment system in which the reducing agent is brought to the indicated temperature by means of a heating element. By means of the heating device, the supplied reducing agent in the form of an aqueous urea solution is evaporated, and decomposed so as to release ammonia, substantially independently of the exhaust-gas temperature when injected into the exhaust-gas flow. As a result, the amount of reducing agent actually present in the exhaust-gas flow is independent of the exhaust-gas temperature.

A similar system to this is known from DE 10 2006 049 591 A1 or from DE 10 2007 029 674 A1, in which likewise a reducing agent in the form of a urea solution is pre-heated by means of an electrically operated heat exchanger and injected in the gaseous state into the exhaust-gas flow.

As already explained in the introduction, the use of a urea solution is associated with certain problems, in particular the need for a further liquid, which may be replenished, to be carried on board in addition to the fuel itself.

EP 0 708 230 B1 therefore discloses a device for the aftertreatment of exhaust gases of an auto-ignition internal combustion engine, in which device, by means of the fuel pump of the diesel engine, diesel fuel is introduced into the exhaust-gas flow via an injection nozzle upstream of an SCR catalytic converter. That is to say, in said described arrangement, instead of an ammonia-releasing system, diesel fuel is used as reducing agent. In order that, in the above-described arrangement, the diesel fuel is injected in gaseous form into the exhaust tract regardless of the exhaust-gas temperature, there is situated in the vicinity of the injection device a glow plug by means of which the diesel fuel is heated to above its evaporation temperature. Said solution duly has the advantage that, in contrast to the above-described systems, there is no need for an additional storage tank for the aqueous urea solution to be provided, which often leads to space problems in particular in the case of passenger motor vehicles.

In said system, however, it is in part perceived to be disadvantageous that relatively large amounts of diesel fuel are utilized for the elimination of nitrogen oxide, which ultimately increases fuel consumption. Furthermore, reaction products are in turn formed here which may have an adverse effect on the exhaust-gas values or which are to be removed again by means of corresponding devices, that is to say generally catalytic converters. Residues of the injected diesel fuel may moreover lead to undesired deposits in the exhaust system.

The inventor herein has recognized the issues with the above approaches and offers a solution to at least partly address them. Accordingly, an injection device for feeding reducing agents into an exhaust-gas purification system of an internal combustion engine for reduction of nitrogen oxide emissions is provided. The injection device comprises an injector, and an evaporation device for evaporating first and second reducing agents, the injection device connected to in each case one storage vessel for the first reducing agent and a storage vessel for the second reducing agent, the first and second reducing agents liquid at room temperature.

The use of said two different reducing agents is advantageous because, through the partial replacement of the aqueous solution while maintaining the same rate of nitrogen oxide elimination, the consumption of urea solution which may additionally be carried on board can be considerably reduced. At the same time, through the combination of urea solution and diesel fuel, the additional pollutant fraction arising from the injection of diesel fuel is considerably reduced. Furthermore, the additional fuel consumption is reduced through the use of the ammonia-releasing liquid.

In this way, a substantially complete elimination of the nitrogen oxides in the exhaust-gas flow is possible, regardless of the temperature thereof, using the smallest possible amounts of reducing agent. In addition, further pollutant loading and contamination of the exhaust system is avoided to the greatest possible extent.

In other words, the above approach provides the use of two liquid reducing agents which are changed into the gaseous state before being injected into the exhaust-gas flow. For this purpose, the evaporation device may for example have an electrically operated heating device, in particular a glow plug.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a known injection device as per the prior art for an aqueous urea solution.

FIG. 2 shows an injection device according to the disclosure for an aqueous urea solution and diesel fuel.

FIG. 3 is a flow chart illustrating an example method for reducing nitrogen oxides.

FIG. 4 is a flow chart illustrating an example method for injecting reducing agents.

### DETAILED DESCRIPTION

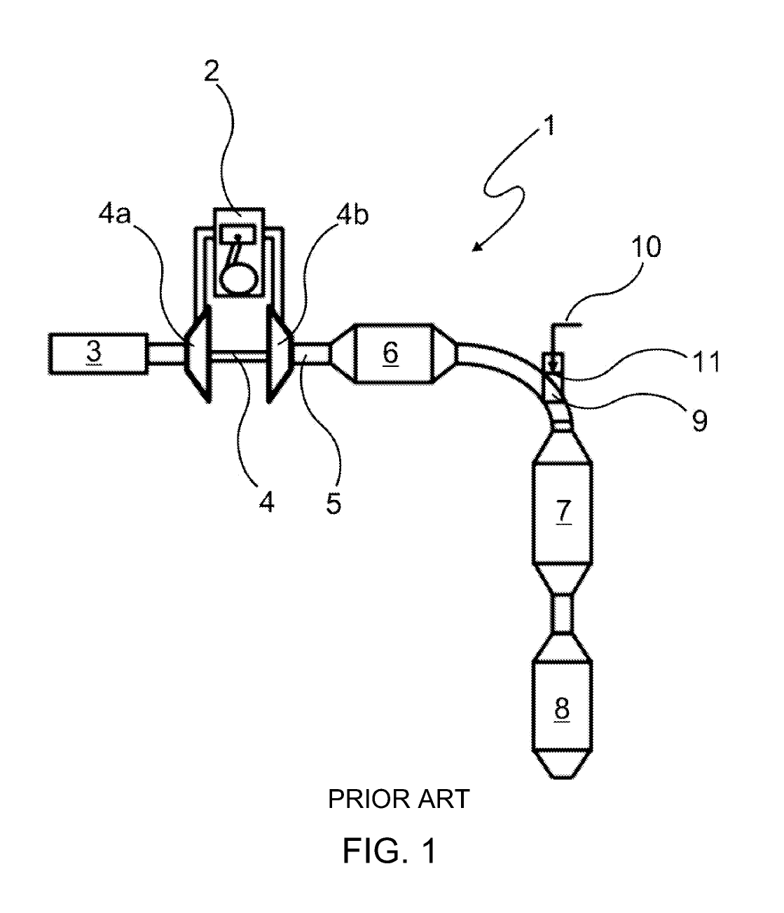

Turning now to FIG. 1, it schematically illustrates the layout of a diesel engine according to previously known systems with connected exhaust-gas purification system 1, analogous to DE 103 48 800 A1. The system comprises a reciprocating-piston engine 2 in the form of a diesel engine with turbocharging, which diesel engine draws in fresh air on its intake side via an air filter 3, said fresh air being pre-compressed by a compressor 4a of a turbocharger 4. In a manner known per se, the compressor 4a of the turbocharger 4 is driven by the turbine 4b thereof, which is at the exhaust-gas side, via a common shaft.

The combustion gases of the reciprocating-piston engine 2 are discharged through an exhaust pipe 5 composed of multiple pipe segments. Arranged in the exhaust pipe 5 downstream of the turbocharger 4 is an oxidation catalytic converter 6, to the outlet side of which in the downstream direction of the exhaust pipe 5 is connected an SCR catalytic converter 7, to the outlet of which is connected, in turn, a rear silencer 8. Between the oxidation catalytic converter 6 and the SCR catalytic converter 7 is positioned an injection device 9 for aqueous urea solution (AdBlue®). Via said injection device, aqueous urea solution supplied via a reducing agent supply line 10 is evaporated at an electrically operated heating element and thereby introduced in gaseous form into the exhaust pipe 5.

The nitrogen oxides generated during the operation of the turbodiesel engine 2 are initially stored in the SCR catalytic converter and, by means of ammonia gas generated during the decomposition reaction of the urea upon contact with the heating element 11 or the hot exhaust gases, is converted into water vapor and nitrogen in a comproportionation reaction.

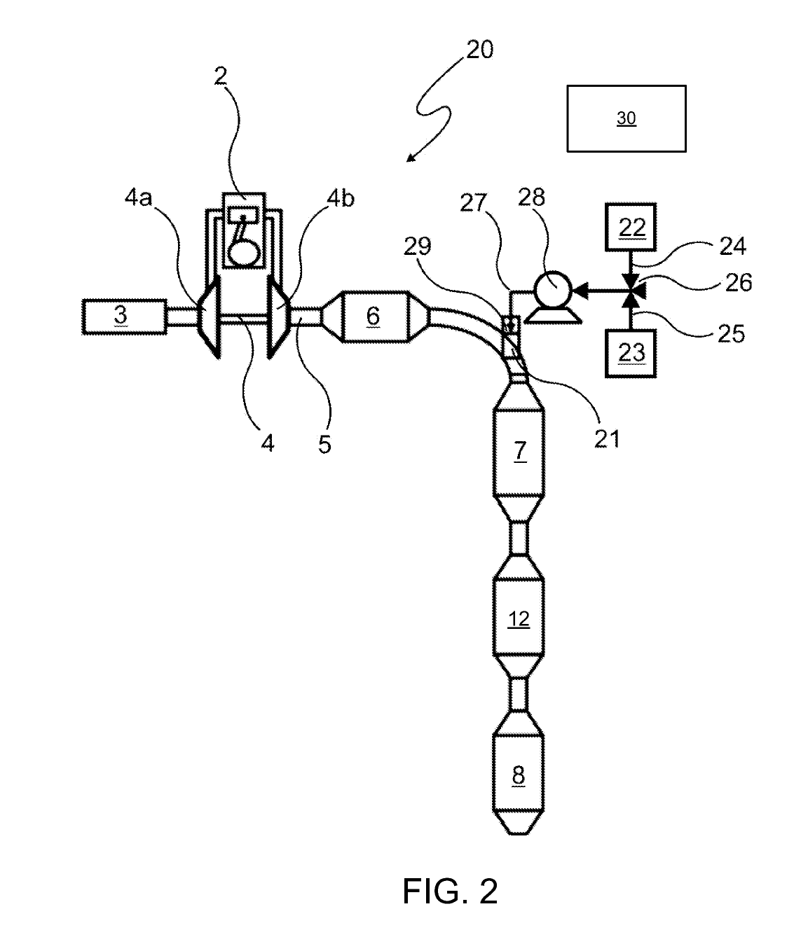

The exhaust-gas purification system 1 of FIG. 1 relies solely on urea to reduce nitrogen oxides in the SCR device. However, in doing so, a relatively large urea tank is needed to provide the indicated urea. This large tank occupies a large amount of packaging space in the vehicle, thus increasing its overall size, reducing the efficiency of the vehicle. The exhaust-gas purification system of the present disclosure, described below with respect to FIG. 2, minimizes the size of the urea tank by utilizing two reducing agents. An injection device is provided which is configured to simultaneously inject both reducing agents, which are stored in separate tanks.

The injection device according to the disclosure may in principle be used in any type of exhaust-gas treatment systems having an SCR catalytic converter. It is possible, in a manner known per se, for further catalytic converters such as an LNT or a soot particle filter to be used in addition to the SCR catalytic converter. The present disclosure consequently also relates to an exhaust-gas purification system for an internal combustion engine for the reduction of the nitrogen oxide emissions, comprising an SCR catalytic converter and, arranged upstream thereof, an injection device according to the disclosure, and also comprising optional further purification elements such as an LNT and/or a soot particle filter which are arranged selectively upstream of the injection device or downstream of the SCR catalytic converter. As an SCR catalytic converter, use may be made in principle of any SCR catalytic converter known per se. The same applies to the optionally provided further purification elements such as an LNT and/or a soot particle filter.

In an advantageous refinement of the injection device according to the disclosure, the first reducing agent is a liquid which releases ammonia, in particular an aqueous urea solution such as AdBlue®, and the second reducing agent is a hydrocarbon compound, in particular a fuel such as for example diesel fuel.

The ratio of diesel fuel to 32.5% urea solution may be varied over wide ranges, and may also be individually adapted as a function of the operating parameters of the vehicle. It is possible for the ratio between the aqueous urea solution of the above-stated concentration, that is to say AdBlue®, to diesel fuel to lie in the range from 1:10 to 10:1, preferably 1:8 to 8:1.

The injection device according to the disclosure may furthermore be designed such that an ammonia line extends from the storage vessel for the liquid which releases ammonia, and a fuel line extends from the fuel storage vessel, which ammonia line and fuel line open out in a 3-way valve which is connected to the injector via a reducing agent line. By means of the 3-way valve, it is possible, by means of a for example electronically actuated adjustment unit, for the abovementioned volume ratios between the two reducing agents to be variably adjusted, in particular as a function of the operating parameters of the engine.

Even though an aqueous urea solution and diesel fuel cannot be mixed homogeneously with one another, it is advantageous for the two reducing agents to be introduced into the exhaust-gas flow in as uniformly distributed a manner as possible. For this purpose, a mixing device may be provided which is preferably arranged in the reducing agent line. By means of said mixing device, an emulsion can be generated from the abovementioned liquid reducing agents.

To permit as quantitative as possible an evaporation of the reducing agents before they are introduced into the exhaust-gas flow, the reducing agent line is advantageously directed toward the heating device in the delivery direction of the reducing agent.

In a further refinement of the injection device according to the disclosure, said injection device is assigned at least one delivery device for the first and second reducing agents, which delivery device is provided in particular in the reducing agent line. A continuous flow of reducing agent can be ensured in this way. A pump, for example, is used as a delivery device. Said pump can furthermore build up a delivery pressure such that the reducing agent is forced with positive pressure towards the heating device and then into the exhaust-gas flow. In this way, the reducing agents can be finely distributed for example by means of an atomizer nozzle before being evaporated, which further accelerates the evaporation process.

In a preferred embodiment of the injection device according to the disclosure, the mixing device is integrated into the delivery device.

The present disclosure also relates to a method for the reduction of nitrogen oxides in exhaust gases, in particular in exhaust gases of diesel internal combustion engines, which method comprises exhaust-gas treatment by means of an SCR catalytic converter, wherein by means of an injection device arranged upstream of the SCR catalytic converter, a first and a second reducing agent which are liquid at room temperature are at least partially evaporated by means of a heating device and are admixed to the exhaust-gas flow by means of an injector.

The present disclosure furthermore relates to the use of a mixture of a hydrocarbon compound, in particular diesel fuel, and of a reducing agent which releases ammonia, in particular an aqueous urea solution such as AdBlue®, for the reduction of nitrogen oxides in exhaust gases, in particular in exhaust gases of diesel internal combustion engines.

FIG. 2 illustrates an exhaust-gas purification system 20 having an injection device 21 according to the disclosure for feeding reducing agents into the exhaust system of the turbodiesel engine 2. Here, the same reference symbols are used to denote components identical to those in the known device from FIG. 1. Therefore, only the significant differences of the two systems will be discussed below.

The injection device 21 is connected to in each case one storage vessel 22, 23 for a first and second reducing agent, that is to say 32.5% aqueous urea solution on the one hand and diesel fuel on the other hand. The connection from the storage vessel 22 for the aqueous urea solution is realized by means of an ammonia line 24 and the connection from the storage vessel 23 for diesel fuel is realized by means of a fuel line 25. The ammonia line 24 and the fuel line 25 open out in an electronically controllable 3-way valve 26 from which there extends a reducing agent line 27 which opens out in an injector. Said injector is composed of an atomizer nozzle (not illustrated here). In the reducing agent line 27 there is provided a delivery device 28 with integrated mixing unit, by means of which the two reducing agents are delivered, mixed and forced under pressure into the injector. Within the injector, the reducing agent flow is directed toward a heating device 29. The heating device 29 is composed of an electrically heated glow plug, by means of which the mixture of aqueous urea solution and diesel fuel is evaporated and, in the process, the urea is at least partially decomposed to form ammonia and carbon dioxide before said gaseous mixture is fed into the part of the exhaust pipe 5 upstream of the SCR catalytic converter 7.

An engine controller 30 includes a microprocessor unit, input/output ports, an electronic storage medium for executable programs and calibration values e.g., a read only memory chip, random access memory, keep alive memory, and a data bus. Controller 30 may receive various signals from sensors coupled to engine 2, including measurement of inducted mass air flow (MAF) from a mass air flow sensor; engine coolant temperature (ECT) from a temperature sensor; a profile ignition pickup signal (PIP) from a Hall effect sensor (or other type) coupled to the engine crankshaft; throttle position (TP) from a throttle position sensor; and absolute manifold pressure signal, MAP, from a pressure sensor. Engine speed signal, RPM, may be generated by controller 30 from signal PIP. Manifold pressure signal MAP from a manifold pressure sensor may be used to provide an indication of vacuum, or pressure, in the intake manifold. Note that various combinations of the above sensors may be used, such as a MAF sensor without a MAP sensor, or vice versa. During stoichiometric operation, the MAP sensor can give an indication of engine torque. Further, this sensor, along with the detected engine speed, can provide an estimate of charge (including air) inducted into the cylinder. In one example, the Hall effect sensor, which is also used as an engine speed sensor, may produce a predetermined number of equally spaced pulses every revolution of the crankshaft. Controller 30 may send signals to control various engine actuators, including valve 26, heating device 29, and other actuators.

The storage medium read-only memory of controller 30 can be programmed with computer readable data representing instructions executable by the processor for performing the methods described below as well as other variants that are anticipated but not specifically listed.

Additional components may be optionally included upstream or downstream of SCR catalytic converter 7. For example, an LNT or soot filter may be positioned either upstream or downstream of the SCR catalytic converter 7. As shown in FIG. 2, a soot filter 12, such as a diesel particulate filter, is positioned downstream of SCR catalytic converter 7.

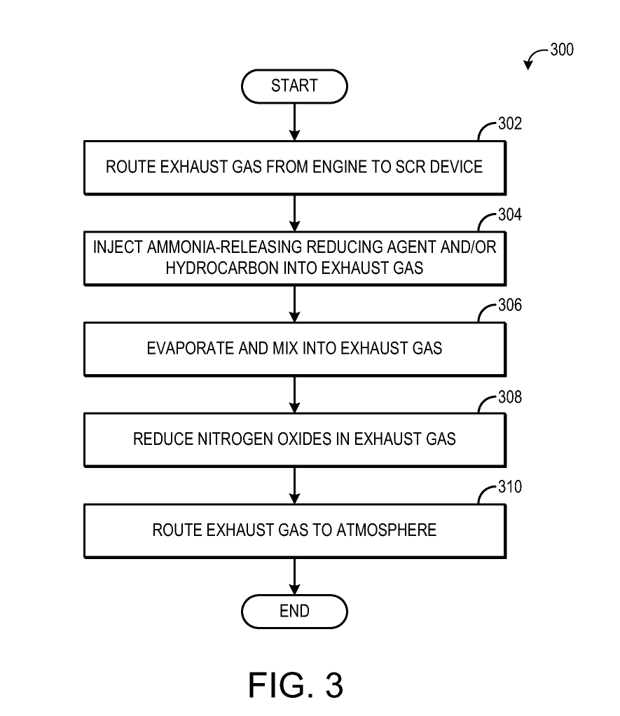

FIG. 3 is a flow chart illustrating a method 300 for reducing nitrogen oxides in an exhaust gas flow. Method 300 may be performed in an engine including an SCR catalyst and an injection device according to the disclosure, as described above. Method 300 includes, at 302, routing exhaust gas from an engine to an SCR catalyst. As explained previously, exhaust gas may include various emissions, such as nitrogen oxides, that may be converted into non-toxic compounds (oxygen, water, etc.) via one or more exhaust emission control devices, including SCR catalysts.

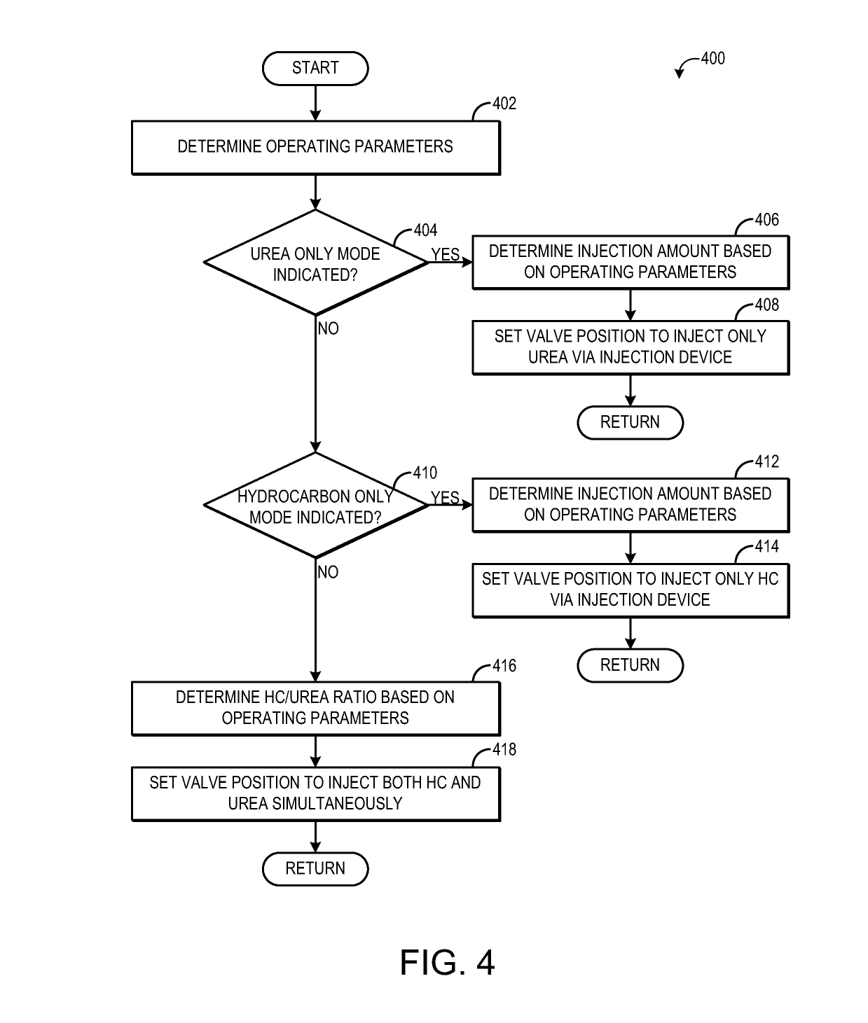

SCR catalysts rely on an external reducing agent to selectively catalyze the reduction of nitrogen oxides. As explained previously, the injection device is configured to deliver both a hydrocarbon-based reducing agent (such as diesel fuel) and an ammonia-releasing reducing agent (such as urea) to the SCR catalyst. Thus, method 300 includes, at 304, injecting an ammonia-releasing agent and/or a hydrocarbon agent into the exhaust gas, upstream or at the inlet of the SCR device. The injection device may inject a single reducing agent or both reducing agents into the exhaust gas simultaneously. Additional detail regarding the relative ratio and amount of each injected reducing agent will be discussed below with respect to FIG. 4.

At 306, method 300 includes evaporating and mixing the agents into the exhaust gas. The injection device may include a heater, such as a glow plug, to heat and evaporate the reducing agents. In this way, the evaporation of the reducing agents may be carried out independent of the temperature of the exhaust gas. A mixer may also be present to mix the reducing agents into the exhaust gas. Further, the delivery device used to deliver the reducing agents for injection (e.g., a pump) may pressurize the reducing agents, thus facilitating the evaporation and mixing of the reducing agents.

At 308, the nitrogen oxides in the exhaust are reduced in the SCR catalyst, as a result of the injection of the reducing agents. After the nitrogen oxides are reduced and/or stored in the SCR catalyst, the exhaust gas is routed out of the SCR catalyst and to the atmosphere, as indicated at 310. Method 300 then ends.

FIG. 4 illustrates a method 400 for injecting reducing agent into an SCR catalyst. Method 400 may be carried out an engine controller, such as controller 30. Method 400 may be carried out with method 300, described above, in order to determine the amounts and ratios of the two reducing agents for injection. Method 400 includes, at 402, determining engine operating parameters. Determined engine operating parameters may include engine speed, engine load, exhaust gas temperature, air-fuel ratio, tank levels of each reducing agent, and other parameters.

At 404, it is determined, based on the operating parameters, if the vehicle is operating in a urea-only mode. During the urea-only mode, only urea (or other ammonia-releasing reducing agent) is injected to the SCR, and not hydrocarbon. The vehicle may operate in the urea-only mode when tank levels of the hydrocarbon are low, or when conditions are more favorable for utilizing urea rather than hydrocarbons, such as when exhaust gas temperatures are relatively high and/or when engine speed and load conditions indicate a high level of NOx is being produced by the engine (e.g., high engine load conditions). If it is determined that the vehicle is not operating in a urea-only mode, method 400 proceeds to 410, which will be described below.

If the engine is operating in a urea-only mode, method 400 proceeds to 406 to determine an amount of urea to inject based on operating conditions. For example, if the engine is operating with high load, more urea may be injected than if the urea is operating under lower load. At 408, the position of the three-way valve is set to only inject urea, and then method 400 returns.

If the vehicle is not operating in urea-only mode, method 400 determines at 410 if the vehicle is operating in hydrocarbon-only mode. HC-only mode may be indicated if the urea tank is empty or low, if the exhaust gas is of a low temperature (as urea vaporizes less efficiently at low temperatures), and/or if NOx levels are relatively low. Further, if a diesel particulate filter (DPF) downstream of the injection site is undergoing a regeneration event, hydrocarbons may be injected to facilitate the regeneration of the DPF. If the vehicle is operating in a HC-only mode, method 400 proceeds to 412 to determine the amount of hydrocarbons to inject. The amount of hydrocarbons may be based on NOx levels, DPF regeneration state, and exhaust gas temperature and air-fuel ratio, or other parameters. At 414, the valve position is set to inject only hydrocarbons, and then method 400 returns.

Returning to 410, if it is determined that the vehicle is not operating in HC-only mode, then the vehicle is operating in a dual-reducing agent mode, and method 400 proceeds to 416 to determine the ratio of urea to hydrocarbons and overall amount of reducing agent to inject. The ratio of urea to HC may vary based on conditions. For example, during high load, high levels of NOx may be produced, and thus a higher level urea may be injected than during low NOx conditions. In another example, if the exhaust gas temperature is low (e.g., below a light-off temperature for a downstream catalyst), more hydrocarbons may be injected than when the temperature is relatively high, as under some conditions, the injected hydrocarbons may increase the temperature of the exhaust gas. In a still further example, the amount of each reducing agent injected may be based on the tank levels of each reducing agent. If the hydrocarbon reducing agent is diesel fuel stored in the engine fuel tank, and if the fuel tank is near empty, it may be disadvantageous to inject a large amount of diesel fuel, and thus more urea may be injected. Other parameters for determining the amounts of the reducing agents are possible.

At 418, the three-way valve position is set to inject both urea and hydrocarbons, in the relative proportions determined above. Method 400 then returns.

Thus, method 400 provides for adjusting the amounts and/or ratio of the two reducing agents based on operating conditions. In some conditions, such as during a regeneration event of a downstream soot filter, it may be more beneficial to inject hydrocarbons rather than urea, to help facilitate the regeneration, and thus the mixture of reducing agents injected may contain more (or only) hydrocarbons. In other conditions, such as high engine load, it may be more beneficial to inject urea, and thus the mixture of the reducing agents may contain more urea. Further, as the amounts and ratios of the reducing agents change, other parameters may be adjusted in response. For example, as the ratio of the reducing agents changes, the heating device configured to evaporate the injected reducing agents may be adjusted. As urea vaporizes at a higher temperature than diesel fuel, the heater may be adjusted to heat to a higher or temperature and/or for a longer duration if the mixture of reducing agents contains more urea than hydrocarbons.

It will be appreciated that the configurations and methods disclosed herein are exemplary in nature, and that these specific embodiments are not to be considered in a limiting sense, because numerous variations are possible. For example, the above technology can be applied to V-6, 1-4, 1-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An injection device for feeding reducing agents into an exhaust-gas purification system of an internal combustion engine for reduction of nitrogen oxide emissions, the injection device comprising:
an injector; and
an evaporation device for evaporating first and second reducing agents, the injection device connected to in each case one storage vessel for the first reducing agent and a storage vessel for the second reducing agent, the first and second reducing agents liquid at room temperature.

2. The injection device as claimed in claim 1, wherein the evaporation device has an electrically operated heating device.

3. The injection device as claimed in claim 2, wherein the electrically operated heating device comprises a glow plug.

4. The injection device as claimed in claim 1, wherein the first reducing agent is a liquid which releases ammonia, and wherein the second reducing agent is a hydrocarbon compound.

5. The injection device as claimed in claim 4, wherein the first reducing agent comprises an aqueous urea solution and the second reducing agent comprises diesel fuel.

6. The injection device as claimed in claim 4, wherein an ammonia line extends from the storage vessel for the liquid which releases ammonia, and a fuel line extends from the fuel storage vessel, which ammonia line and fuel line open out in a 3-way valve which is connected to the injector via a reducing agent line.

7. The injection device as claimed in claim 6, wherein a mixing device is provided in the reducing agent line.

8. The injection device as claimed in claim 6, wherein the reducing agent line is directed toward the heating device in a delivery direction.

9. The injection device as claimed in claim 1, wherein the injection device is assigned at least one delivery device for the first and second reducing agent, said delivery device being provided in a reducing agent line.

10. The injection device as claimed in claim 9, wherein a mixing device is integrated into the delivery device.

11. An exhaust-gas purification system for an internal combustion engine for reduction of nitrogen oxide emissions, comprising:
the injection device as claimed in claim 1;
an SCR catalytic converter arranged downstream of the injection device; and
an LNT and/or a soot particle filter arranged selectively upstream of the injection device or downstream of the SCR catalytic converter.

12. A method for the reduction of nitrogen oxides in exhaust gases, comprising:
treating exhaust-gas flow via an SCR catalytic converter;
at least partially evaporating a first and a second reducing agent which are liquid at room temperature via a heating device, the first and a second reducing agent injected by an injection device arranged upstream of the SCR catalytic converter; and
admixing the first and a second reducing agent to the exhaust-gas flow by an injector.

13. The method as claimed in claim 12, wherein a volume ratio of first to second reducing agent is 10:1 to 1:10.

14. The method as claimed in claim 13, wherein the volume ratio of first to second reducing agent is 8:1 to 1:8

15. A method, comprising:
reducing nitrogen oxides in exhaust gases of a diesel internal combustion engine via a mixture of a hydrocarbon compound and of a reducing agent which releases ammonia.

16. The method of claim 15, wherein the hydrocarbon compound comprises diesel fuel.

17. The method of claim 15, wherein the reducing agent comprises an aqueous urea solution.

18. The method of claim 15, wherein the mixture comprises a ratio of the reducing agent which releases ammonia to the hydrocarbon compound within a range of 1:8 to 8:1.

19. The method of claim 15, wherein the mixture comprises more hydrocarbon compound than the reducing agent which releases ammonia during a regeneration event of a downstream soot filter.

20. The method of claim 15, wherein the mixture comprises more reducing agent which releases ammonia than hydrocarbon compound during high engine load conditions.
